(19) United States
(12) Patent Application Publication
(10) Pub. No.: US 2005/0089330 A1
(43) Pub. Date: Apr. 28, 2005

(54) Optical communication network

(76) Inventors: Annette C. Grot, Cupertino, CA (US); Kenneth R. Wildnauer, Santa Rosa, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/691,760

(22) Filed: Oct. 23, 2003

(51) Int. Cl. H04B 10/00

(52) U.S. Cl. 398/139

(57) ABSTRACT

An optical communication network in which interoperable optical frequency channels are defined without an absolute frequency reference. In accordance with a first embodiment, non-absolute frequency references identical in frequency are provided to the nodes on the network. At each node, one of the channels of a tunable multi-channel device located at the node is frequency aligned with the non-absolute frequency reference. Once the tunable multi-channel devices have been frequency aligned with the non-absolute frequency reference, respective transceivers located at the respective nodes are frequency aligned to different ones of the channels of the tunable multi-channel device so that they can transmit and receive optical information signals at frequencies defined by the tunable multi-channel device.

### TECHNICAL FIELD

The invention relates to optical communications and, more particularly, to an optical communication network in which carrier frequencies are non-absolute and can change over time.

### BACKGROUND

Optical communication networks utilize wavelength division multiplexing (WDM) in which optical information signals of different frequencies, each representing a respective information signal, are carried by the same optical fiber. The frequencies of the optical information signals are normally standardized by the International Telecommunications Union (ITU) and are absolute in that they are defined in absolute terms by the standard and remain fixed unless the standard is changed. Every node communicating optical information signals over a network uses the same standardized set of absolutely-defined frequencies. Without such a standardized set of absolutely-defined frequencies, communication over the network would break down.

One problem with using a standardized set of absolutely-defined frequencies is that light sources (e.g., lasers) used to generate the optical information signals must be manufactured with great precision to ensure that they generate light at the frequencies specified by the standard. If the light sources are not precisely manufactured, the light they generate may differ in frequency from the standard. Also, the light sources can drift in frequency due to temperature changes, aging and other factors. Therefore, even if the light sources were sufficiently precise in frequency when they were made, they may become imprecise over time. In addition, the light sources at the transmitter and the light sensors at the receiver need to be kept in temperature-controlled environments to maintain their precision. All of these constraints increase the cost of optical communication networks.

What is needed, therefore, is an optical communication network in which the frequencies of the optical information signals over the network do not have to be defined with an absolute precision that has to be maintained over the operational life of the network.

### SUMMARY

The invention provides an optical communication method in which interoperable optical frequencies are defined without an absolute frequency reference. In accordance with a first embodiment of the method, non-absolute references identical in frequency are distributed to nodes of the network. Respective tunable multi-channel devices are provided to the nodes of the network. The tunable multi-channel devices have channels with mutually-identical frequency differences. At each of the nodes, one of the channels of the tunable multi-channel device located at the node is frequency aligned with the non-absolute frequency reference.

In an embodiment, optical information signals are exchanged between two or more of the nodes at a frequency aligned with another of the channels of the tunable multi-channel device.

In accordance with a second embodiment of the optical communication method, a non-absolute frequency reference and a tunable multi-channel device are provided. The tunable multi-channel device is frequency alignable with the non-absolute frequency reference and has channels with stable, defined frequency differences. Optical information signals are transmitted and/or optical information signals are received at one or more frequencies, each frequency aligned with a respective one of the channels of the multi-channel device.

In first variation, non-absolute frequency reference signals are generated frequency aligned with the channels of the tunable multi-channel device and are broadcast to the nodes. At each of the nodes, the non-absolute frequency reference signals are received and the one or more frequencies at which the optical information signals are transmitted and/or received are frequency aligned with respective ones of the received non-absolute frequency reference signals.

In a second variation, the tunable multi-channel device is located at one of the nodes, and additional tunable multi-channel devices are located at remaining ones of the nodes. The channels of all the tunable multi-channel devices have stable, mutually-identical frequency differences. The non-absolute frequency reference is distributed to each of the nodes. At each of the nodes, one of the channels of the multi-channel device located at the node is frequency aligned with the non-absolute frequency reference.

The invention also provides an optical communication network in which interoperable optical frequencies are defined without an absolute frequency reference. In a first embodiment, the network comprises means for distributing a non-absolute frequency reference to nodes of the network, and, at each of the nodes, a tunable multi-channel device and a control circuit. The tunable multi-channel devices at all the nodes have channels with mutually-identical frequency differences. The control circuit is operable to frequency align one of the channels of the multi-channel device located at the node with the non-absolute frequency reference.

In a second embodiment of an optical communication network in accordance with the invention, the network comprises a non-absolute frequency reference, a tunable multi-channel device frequency alignable with the non-absolute frequency reference and nodes each comprising a transceiver. The tunable multi-channel device comprises channels having stable, defined frequency differences. The transceiver is operable to transmit optical information signals and/or to receive optical information signals at one or more frequencies each frequency aligned with a respective one of the channels of the multi-channel device.

In a first variation, the network additionally comprises light sources frequency aligned with the channels of the tunable multi-channel device, and each of the nodes comprises a channel selector. The light sources are operable to generate respective non-absolute frequency reference signals for broadcast to the nodes. The channel selector is operable to frequency align the one or more frequencies at which the transceiver is operable to transmit and/or receive the optical information signals with respective ones of the non-absolute frequency reference signals received at the node.

In a second variation, the non-absolute frequency reference is distributed to each of the nodes and the tunable multi-channel device is located at one of the nodes. Remaining ones of the nodes each comprise a tunable multi-channel device. All the tunable multi-channel devices have mutually-identical channel spacings. Each of the nodes comprises a control circuit operable to frequency align one of the channels of the multi-channel device located at the node with the non-absolute frequency reference.

Other features and advantages of the invention will become apparent from the following description, drawings and claims.

### BRIEF DESCRIPTION OF THE DRAWINGS

FIG. 1 is a block diagram of an optical communication network in accordance with a first embodiment of the invention in which interoperable optical frequencies are defined without an absolute frequency reference.

FIG. 2 is a block diagram showing a first exemplary embodiment of one of the nodes of the optical communication network shown in FIG. 1.

FIG. 3 is a graph showing the transmitted intensity versus frequency of the Fabry-Perot etalon that forms part of the node shown in FIG. 3 before alignment with the non-absolute frequency reference.

FIG. 4 is a graph showing the transmitted intensity versus frequency of the Fabry-Perot etalon that forms part of the node shown in FIG. 3 after alignment with the non-absolute frequency reference.

FIG. 5 is a block diagram showing a second exemplary embodiment of one of the nodes of the optical communication network shown in FIG. 1.

FIG. 6 is a block diagram of an optical communication network in accordance with a second embodiment of the invention in which interoperable optical frequencies are defined without an absolute frequency reference.

FIG. 7 is a flow chart of a first embodiment of an optical communication method in accordance with the invention in which interoperable optical frequencies are defined without an absolute frequency reference.

FIG. 8 is a flow chart of a second embodiment of an optical communication method in accordance with the invention in which interoperable optical frequencies are defined without an absolute frequency reference.

FIG. 9 is a flow chart of a first variation on the optical communication method shown in FIG. 8.

FIG. 10 is a flow chart of a second variation on the optical communication method shown in FIG. 8.

### DETAILED DESCRIPTION

Absolutely-defined optical frequencies are needed in optical networks that transmit optical signals to or receive optical signals from one or more other optical networks. However, many optical networks can be regarded as closed networks in which optical signals originating at one or more nodes of the network pass exclusively to one or more other nodes of the network. Such networks never transmit an optical signal to or receive an optical signal from another network. The invention obviates the need for a closed optical network to use absolutely-defined optical frequencies. Instead, the invention allows the optical network to employ accurately and stably defined frequency differences. Frequency differences can be accurately and stably defined at substantially less cost than absolute frequencies. Yet, accurately and stably defined frequency differences allow multiple optical signals to be transmitted simultaneously through an optical network without the risk of interference and cross-talk among the optical signals.

In accordance with the invention, an optical communication network is provided in which optical information signals are transmitted and received at optical frequencies that are not absolutely defined and that can change over time. The optical communication network is composed of a number of nodes at which optical information signals representing respective information signals are transmitted, received, or both transmitted and received. The nodes are interconnected by optical links, typically optical fibers. The optical information signals have mutually-different frequencies with accurately and stably defined frequency differences so that optical information signals can be transmitted and received by more than one of the nodes simultaneously without the risk of interference and cross-talk.

In a first embodiment of an optical network in accordance with the invention, non-absolute frequency references that are identical in frequency are distributed to the nodes of the network. A tunable multi-channel device whose channels have stable, accurately defined frequency differences is located at each of the nodes. All the tunable multi-channel devices have mutually-identical frequency differences. At each of the nodes, one of the channels of the multi-channel device is frequency aligned with the non-absolute frequency reference.

The non-absolute frequency references can be distributed to the nodes of the network by broadcasting a non-absolute frequency reference signal at a particular optical frequency to the nodes. The non-absolute frequency reference signal may be modulated with characteristic modulation that identifies it as a non-absolute frequency reference signal. In an embodiment, the characteristic signal is a small frequency dither that assists the frequency alignment of one of the channels of the tunable multi-channel device to the non-absolute frequency reference signal.

Alternatively, the non-absolute frequency references can be distributed to the nodes of the network by providing to the nodes non-absolute frequency reference artifacts, such as non-absolute frequency reference artifacts based on an atomic absorption line. The non-absolute frequency reference artifacts are identical in frequency. One of the channels of the multi-channel device located at the node is frequency aligned with the non-absolute frequency reference artifact. This is typically done by generating a non-absolute frequency reference signal at the node using the non-absolute frequency reference artifact, and then aligning one of the channels of the tunable multi-channel device located at the node to the non-absolute frequency reference signal.

The non-absolute frequency reference can be distributed to some of the nodes of the network by providing identical non-absolute frequency reference artifacts to such nodes. The non-absolute frequency reference artifact at one of the nodes is used to generate a non-absolute frequency reference signal that is broadcast to the remaining nodes of the network. The non-absolute frequency reference can be distributed to the nodes of the network in ways other than those described.

Each node of the optical communication network transmits an optical information signal of a different frequency through the network so that the nodes can simultaneously communicate using the network. To this end, after one of the channels of the tunable multi-channel device located at each node has been frequency aligned with the non-absolute frequency reference, a channel selector located at the node is used to frequency align a transmitter laser at the node with one of the channels of the tunable multi-channel device. The transmitter laser at the node is subsequently used to transmit an optical information signal over the network at the non-absolute frequency defined by this channel of the tunable multi-channel device. A node that transmits an optical information signal will be called a “transmitting node” in the following description.

The channel of the tunable multi-channel device with which the transmitter laser at the transmitting node is frequency aligned is not absolutely defined in frequency, because the frequency of the non-absolute frequency reference is not absolutely defined. However, the frequency difference between the channels of the tunable multi-channel device is stable, accurately defined and is the same for the tunable multi-channel devices located at all the nodes of the network. Thus, an optical information signal at a frequency aligned with any of the channels of the tunable multi-channel device will be spaced in frequency from an optical signal at a frequency aligned with any other of the channels of the tunable multi-channel device by the channel spacing defined by the tunable multi-channel device. Provided that the channel spacing of the tunable multi-channel device is sufficient to accommodate the bandwidth of the optical information signals, cross-talk between simultaneously transmitted optical information signals in adjacent channels is avoided.

Another node of the network that is to receive an optical information signal from the transmitting node just described will be called a “receiving node”. At the receiving node, a channel of the tunable multi-channel device is frequency aligned the non-absolute frequency reference, and a channel selector located at the receiving node is used to frequency align a receiver laser located at the receiving node with the same channel of the tunable multi-channel device located at the receiving node as the channel of the tunable multi-channel device located at the transmitting node with which the transmitter laser was frequency aligned. As noted above, the frequency of this channel of the tunable multi-channel devices located at the transmitting node and the receiving node is not absolutely defined, because the non-absolute frequency reference is not absolutely defined. However, the frequency difference between the channels of the tunable multi-channel devices is accurately defined and is the same for the tunable multi-channel devices at all the nodes. The transmitting node subsequently transmits an optical information signal over the network at the non-absolute frequency of the selected channel of the tunable multi-channel device and the optical information signals are received at the receiving node where the receiver laser is also frequency aligned with the selected channel of the tunable multi-channel device at the receiving node.

A second embodiment of an optical communication network in accordance with the invention comprises a non-absolute frequency reference, a tunable multi-channel device frequency alignable with the non-absolute frequency reference and nodes each comprising a transceiver. The tunable multi-channel device comprises channels having stable, defined frequency differences. Each transceiver is operable to transmit optical information signals and/or to receive optical information signals at one or more frequencies each frequency aligned with a respective one of the channels of the multi-channel device.

In a first variation, different non-absolute frequency reference signals frequency aligned to the channels of the tunable multi-channel device are broadcast to the nodes. A channel selector located at each of the nodes is operable to frequency align the one or more frequencies at which the transceiver is operable to transmit and/or receive the optical information signals with respective ones of the non-absolute frequency reference signals received at the node.

Although the frequencies of the non-absolute frequency reference signals are not absolutely defined and may change with time, the frequency difference between the non-absolute frequency reference signals is accurately defined by the tunable multi-channel device. Thus, an optical information signal frequency aligned with any of the non-absolute frequency reference signals is spaced in frequency from an optical information signal frequency aligned with any other of the non-absolute frequency reference signals by the defined channel spacing of the tunable multi-channel device, and cross-talk between simultaneously transmitted optical information signals is avoided.

In a second variation, the tunable multi-channel device is located at one of the nodes, and additional tunable multi-channel devices are located at remaining ones of the nodes. The channels of all the tunable multi-channel devices have stable, mutually-identical frequency differences. A non-absolute frequency reference is distributed to each of the nodes. At each of the nodes, one of the channels of the multi-channel device located at the node is frequency aligned with the non-absolute frequency reference.

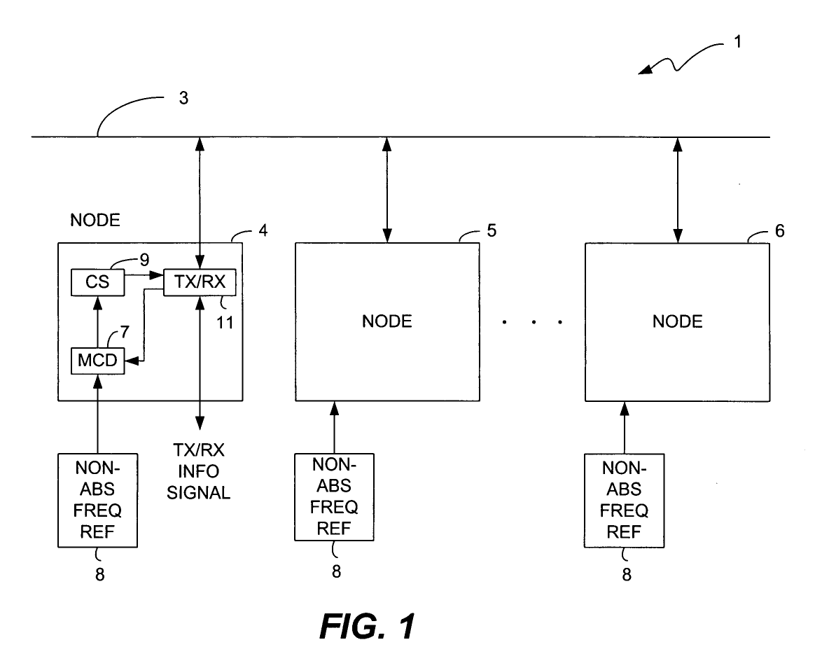

FIG. 1 is a block diagram of an optical communications network 1 in accordance with the first embodiment of the invention. Nodes, exemplary ones of which are indicated by reference numerals 4, 5 and 6, transmit, receive or transmit and receive optical information signals using the network. Only the structure of node 4 is shown in detail FIG. 1. The remaining nodes are similar in structure.

Exemplary node 4 is composed of a tunable multi-channel device (MCD) 7, a channel selector 9 and a transceiver 11. The tunable multi-channel device 7 is frequency alignable to the non-absolute frequency reference 8. Regardless of the tuning of the tunable multi-channel device 7, the frequency differences between the center frequencies of adjacent ones of its channels remains substantially constant. The frequency difference between the channels of the tunable multi-channel device 7 typically is equal to the desired channel spacing of the network 1. Alternatively, the frequency difference between the channels of the tunable multi-channel device 7 may be an integral fraction of the desired channel spacing. In an embodiment, the tunable multi-channel device 7 includes a Fabry-Perot (F-P) etalon.

As stated above, the non-absolute frequency reference 8 at each node may be a non-absolute frequency reference artifact such as an atomic absorption line device, for example, located at the node. Alternatively, the non-absolute frequency reference may be a non-absolute frequency reference signal broadcast via a fiber 3 to all the nodes of the network 1 from a reference source (not shown). In the latter case, the non-absolute frequency reference signal is typically modulated in a manner that identifies it as such, and distinguishes it from other optical signals transmitted through the network.

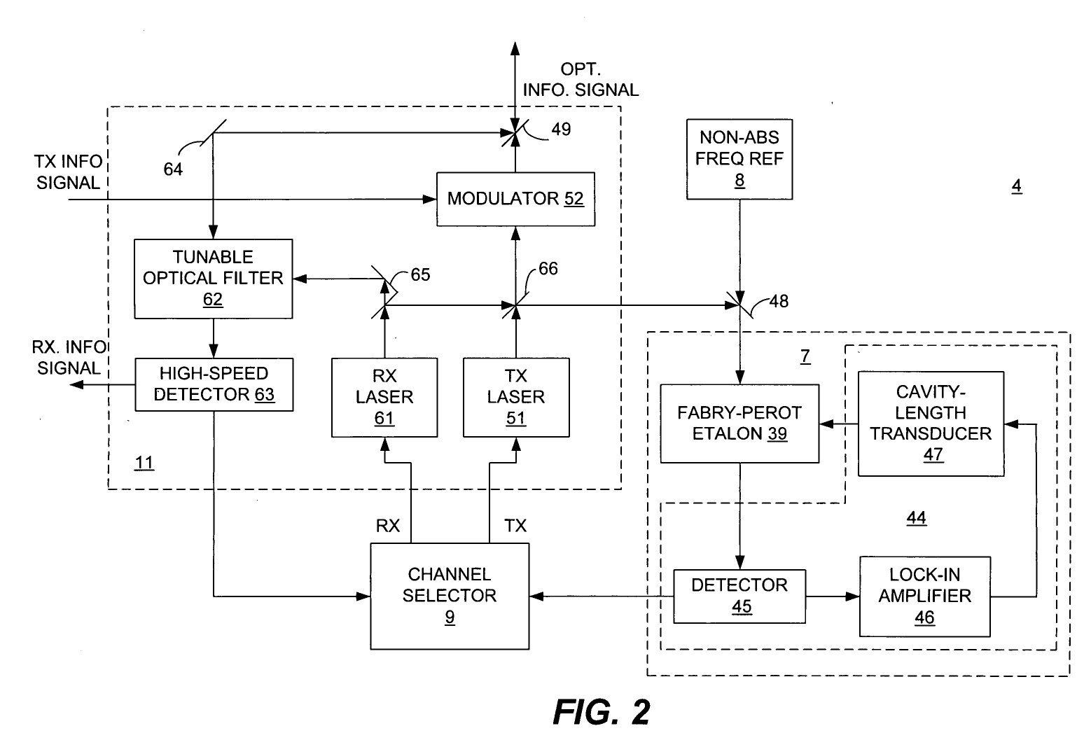

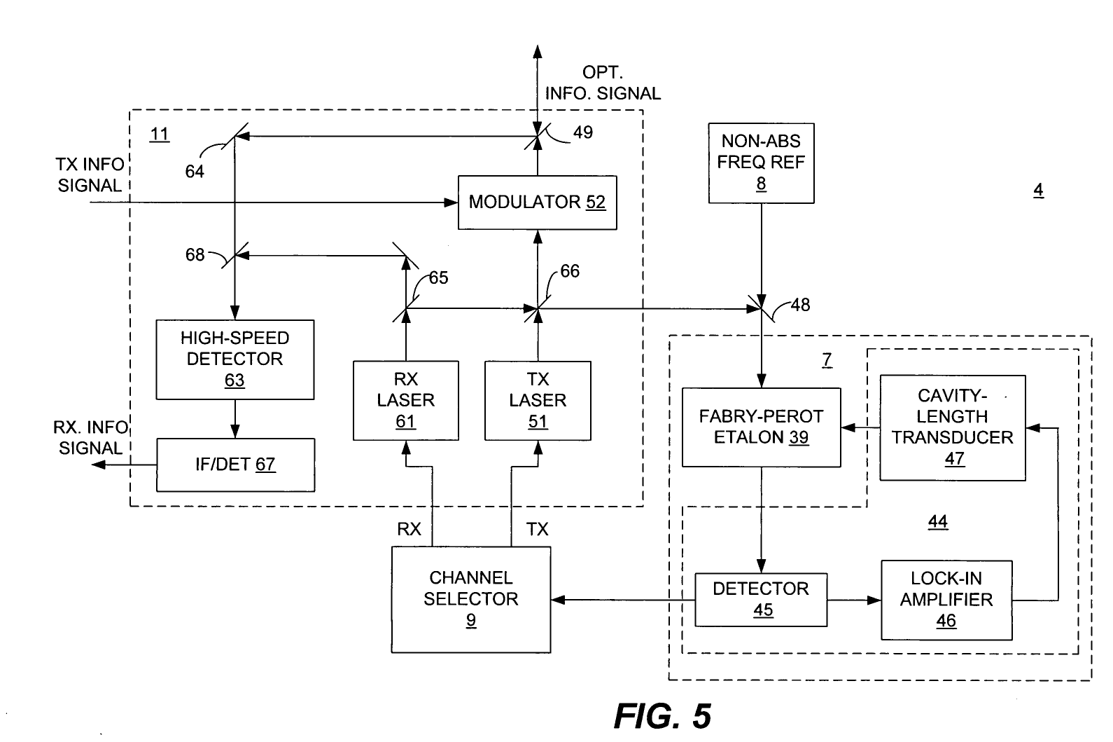

After one of the channels of the tunable multi-channel device 7 has been frequency aligned with the non-absolute frequency reference 8, the channel selector (CS) 9 frequency aligns a laser (not shown) that forms part of the transceiver (T/R) 11 with a channel of the tunable multi-channel device selected by the channel selector 9. In this disclosure, the term transceiver is used to denote a device capable of transmitting only, receiving only or both transmitting and receiving. A transceiver capable of both transmitting and receiving is composed of a transmitter and a receiver: one capable of transmitting only lacks a receiver, one capable of receiving only lacks a transmitter. A transmitter comprises a transmitter laser and a receiver comprises a receiver laser, as will be described in more detail below with reference to FIGS. 2 and 5. The channel selector 9 frequency aligns the transmitter and/or receiver laser of each transceiver 11 with a respective selected channel of the tunable multi-channel device 7. The channels with which the transmitter lasers are aligned differ among the nodes.

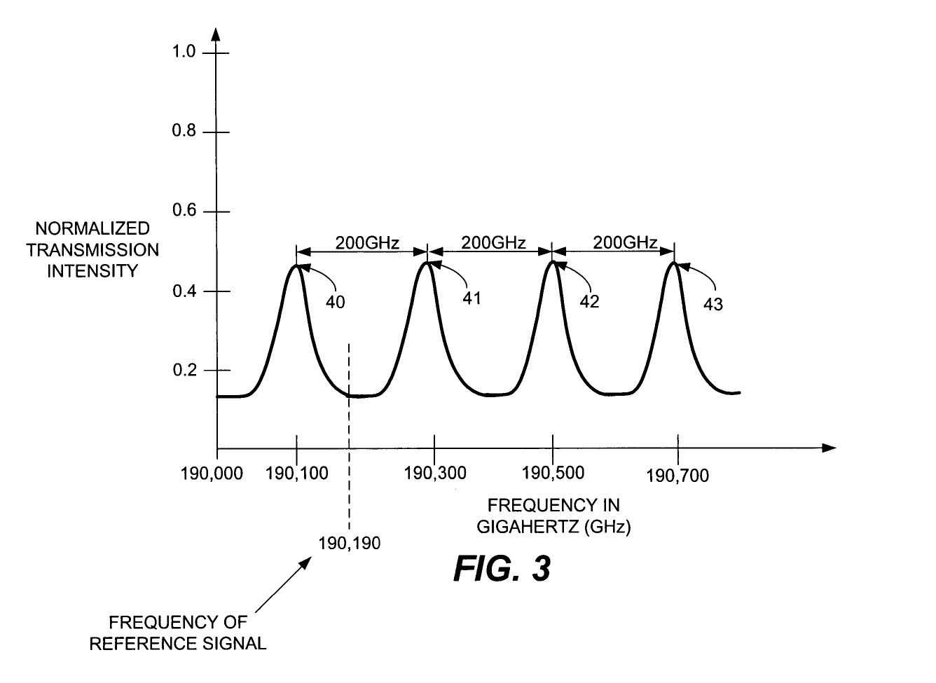

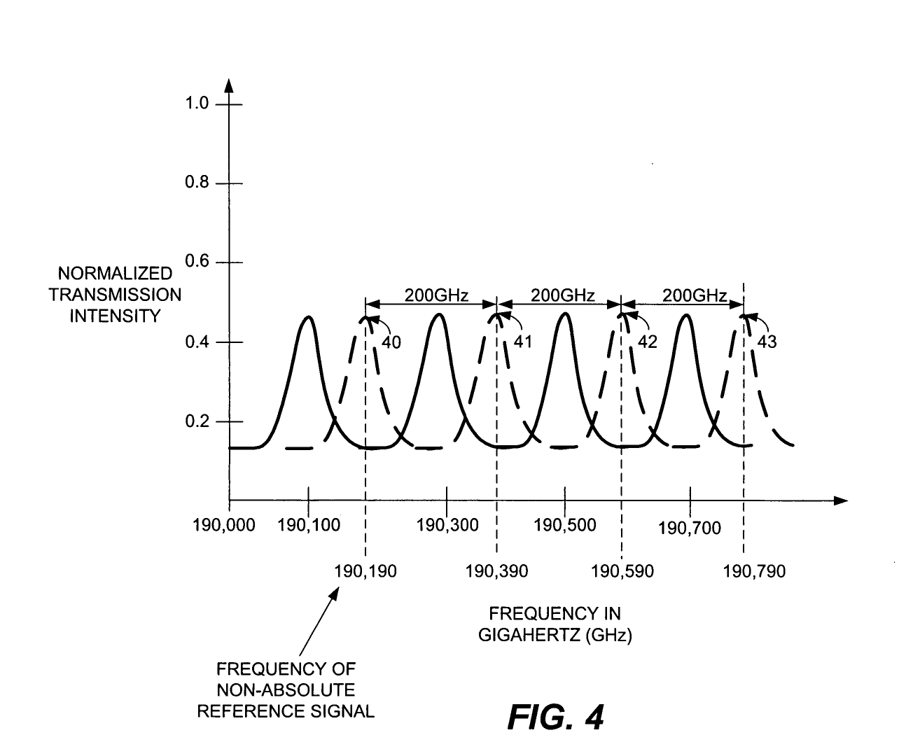

Frequency aligning one of the channels of the multi-channel device 7 with the non-absolute frequency reference 8 changes the frequencies of all of the channels of the multi-channel device 7 but leaves the frequency difference between the channels unchanged, as will be described below in more detail with reference to FIGS. 3 and 4. The channel selector 9 controls the frequencies of the lasers of the transceiver 11 to track the resulting change in the frequency of the selected channel. Consequently, any change in the frequency of the non-absolute frequency reference 8 will translate into a change in the center frequencies of the channels used by the transceiver 11 in each node to transmit and/or receive. Therefore, the frequency that each transmitting node uses to transmit and the frequency a receiving node uses to receive an optical information signal from the transmitting node remain equal to one another, even though the frequency of the non-absolute frequency reference may change. One of the benefits of referencing the frequencies at which the optical information signals are transmitted and received to a non-absolute frequency reference using tunable multi-channel devices is that the transmitters and receivers do not have to be constructed with components that are required to meet and maintain an absolute frequency standard both initially and through the operational life of the equipment. This reduces the overall cost of the optical communication network 1. Another advantage is that referencing the frequencies at which the optical information signals are transmitted and received to a non-absolute frequency reference using tunable multi-channel devices corrects the frequency drift that would otherwise result from, for example, aging of equipment, temperature changes, etc.

As noted above, the remaining nodes of the network 1 have the same structure as the exemplary node 4. In particular, each node includes a tunable multi-channel device whose channels have frequency differences nominally identical to those of tunable multi-channel device 7. As used in this disclosure, the term nominally identical does not necessarily mean equal. The frequency differences between the channels of the tunable multi-channel devices may differ among the tunable multi-channel devices. The maximum variation from equal frequency differences that is allowed difference depends, at least in part, on the difference between the maximum bandwidth of the optical information signals exchanged between the nodes of the network 1 and the nominal frequency differences between the channels of the tunable multi-channel device: a larger difference permits a larger variation from equal frequency differences.

FIG. 2 is a block diagram of a first exemplary embodiment of the node 4 shown in FIG. 1 in which details of the tunable multi-channel device 7 and the transceiver 11 are shown. In accordance with this embodiment, the tunable multi-channel device 7 is composed of an F-P etalon 39 and a control circuit 44. The control circuit 44 is composed of a detector 45, a lock-in amplifier 46 and a cavity-length transducer 47 connected in series. The transmitter portion of the transceiver 11 is composed of a transmitter laser 51 and a modulator 52. The receiver portion of the transceiver 11 is composed of a receiver laser 61, a tunable optical filter 62 and a high-speed detector 63.

The tunable multi-channel device 7 receives a non-absolute frequency reference signal from the above-described non-absolute frequency reference 8. The non-absolute frequency reference signal is either generated by a non-absolute frequency reference artifact, such as an atomic absorption line device, located at the node 4 or is broadcast through the network to the node 4 from a reference source (not shown). The non-absolute frequency reference signal passes through the etalon 39 to a detector 45. The control circuit 44 operates in response to the light illuminating the detector and provides a control signal to the etalon 39 that frequency aligns the resonant peak of the etalon 39 that is nearest in frequency to the non-absolute frequency reference signal with the non-absolute frequency reference signal.

The manner in which a Fabry-Perot etalon 39 operates can be seen from the transmitted intensity-versus-frequency graph shown in FIG. 3. The frequency response exhibits resonance peaks at which transmission through the etalon 39 is a maximum. Only four resonance peaks, indicated by the reference numerals 40, 41, 42 and 43 are shown in FIG. 3 to simplify the drawing. Typical etalons have many more resonance peaks than the number shown. The resonance peaks are at frequencies given by equation 1:
f(m)=m*c/(2nd) (1)
where f(m) is the frequency of the m-th resonance peak, m is an integer greater than zero (m=1, 2, 3 . . . N), c is the speed of light, d is the length of the etalon cavity, i.e., the distance between the mirrors of the etalon, and n is the index of refraction of the material in the etalon cavity (typically air). The frequency spacing Δ(ƒ) between adjacent resonance peaks is given by equation (2):
Δ(f)=f(m+1)−f(m)=c/(2nd) (2)

The center frequency of each resonance peak of the etalon 39 defines the center frequency of one channel of the tunable multi-channel device 7 and, hence, of the network 1. FIG. 3 shows an example of the frequency response of an exemplary embodiment of the F-P etalon 39 shown in FIG. 2 structured to provide a frequency difference Δ(ƒ) between adjacent resonance peaks of 200 gigahertz (GHz) at a frequency of about 190 terahertz (THz). This frequency corresponds to a wavelength of about 1.55 μm. However, the invention is not limited to the particular range of frequencies or the particular frequency difference exemplified.

In accordance with the embodiment of the node 4 shown in FIG. 2, the control circuit 44 tunes the F-P etalon 39 to frequency align the resonance peak of the etalon 39 closest in frequency to the non-absolute frequency reference signal with the non-absolute frequency reference signal. In the example shown in FIG. 3, in which the frequency of the non-absolute frequency reference signal is 190,190 GHz, the frequency of the resonance peak closest in frequency to the non-absolute frequency reference signal is 190,100 GHz. In this example, the control circuit 44 adjusts the cavity length d of the etalon 39 to frequency align the resonance peak 40 with the non-absolute frequency reference signal, i.e., the control circuit adjusts the cavity length to shift the frequency of the resonance peak 40 from 190,100 GHz to 190,190 GHz.

Changing the frequency of the resonance peak 40 changes the frequency differences between adjacent ones of the resonance peaks 40-44 by a fractional amount equal to the fractional amount by which the frequency of the resonance peak 40 is changed. However, the change is very small. In the example just described, in which the frequencies of the resonance peaks are about 190 THz and the frequency difference between adjacent ones of the resonance peaks is 200 GHz, the maximum change in the frequency of the resonance peak nearest in frequency to the non-absolute frequency reference signal required to frequency align the resonance peak with the non-absolute frequency reference signal is ±100 GHz. This change in the frequency of the resonance peak is ±100/190,000 of the frequency of the resonance peak, i.e., ±0.05%. The frequency difference between adjacent ones of the resonance peaks changes by the same fraction, i.e., by ±0.05% in the above example. The frequency differences between adjacent ones of the resonance peaks of the etalon 39 can therefore normally be regarded as remaining constant as the frequency of one of them is changed to frequency align the resonance peak with the non-absolute frequency reference signal. The change in the frequency differences needs to be taken into account only when the number of channels is very large.

Thus, ignoring the very small change in the frequency differences between adjacent ones of the resonance peaks, in the above-described example in which the resonance peak 40 is changed in frequency by 90 GHz from 190,100 GHz to 190,190 GHz to frequency align the resonance peak 40 with the non-absolute frequency reference signal, changing the frequency of the resonance peak 40 by +90 GHz also changes the frequencies of the other resonant peaks 41-43 by +90 GHz.

FIG. 4 is an intensity-versus-frequency graph of the etalon 39 after the frequency of the resonance peak 40 has been changed to frequency align the resonance peak 40 with the non-absolute frequency reference signal. The resonance peaks 40, 41, 42 and 43 shown in FIG. 4 correspond to the resonance peaks 40, 41, 42 and 43 shown in FIG. 3. It can be seen that the frequency differences between adjacent ones of the resonance peaks shown in FIG. 4 is the same as the frequency differences between adjacent ones of the resonance peaks shown in FIG. 3. These frequency differences are 200 GHz in the example shown. As will be described below in detail, the resonance peaks of the tunable multi-channel device 7 correspond to the channels of the network 1, and each optical information signal transmitted through the network 1 is frequency aligned to a different one of the resonance peaks shown in FIG. 4.

To facilitate frequency alignment of one of the resonance peaks of etalon 39 with the non-absolute frequency reference signal, a small dither signal is added to the non-absolute frequency reference signal. The feedback signal generated by the detector 45 in response to the non-absolute frequency reference signal includes a component due to the dither signal and is fed to the lock-in amplifier 46. In response to the dither signal, the lock-in amplifier 46 produces an error signal that is used by the cavity-length transducer 47 to adjust the length of the etalon cavity to frequency align one of the resonance peaks with the non-absolute frequency reference signal. The cavity-length transducer 47 receives the error signal and adjusts the cavity length of the etalon 39 accordingly.

After it has been frequency aligned with the non-absolute frequency reference, the etalon 39 is used to frequency align the transmitter laser 51 in the transceiver 11. The transmitter laser 51 is frequency aligned with one of the resonant peaks of the etalon 39 designated by the channel selector 9. This sets the transmitter laser 51 to generate light at the frequency of one of the channels of the network 1. To effect this tuning, a small sample of the light generated by the transmitter laser 51 is directed by the beam combiner 66 towards the beam combiner 48. The beam combiner 48 spatially overlaps the transmitter laser light sample with the non-absolute frequency reference signal received from the non-absolute frequency reference 8 and the combined beam passes through the etalon 39 to the detector 45. The channel selector 9 is connected to receive the feedback signal generated by the detector 45 in response to the light sample from the transmitter laser 51. The channel selector 9 provides a frequency control signal to the transmitter laser 51. In response to the feedback signal generated by the detector 45, the channel selector 9 generates the frequency control signal that frequency aligns the transmitter laser 51 with a resonance peak of the etalon 39 selected by the channel selector 9. A small dither signal is added to the light generated by the transmitter laser 51 in a manner similar to that described above to facilitate this alignment. The dither signal differs in frequency from that added to the non-absolute reference signal to allow the channel selector 9 and the lock-in amplifier 46 to distinguish components of the feedback signal generated by the detector 45 originating from the sample of the light from the transmitter laser 51 and the non-absolute frequency reference signal, respectively.

In an example, the channel selector 9 designates, as the frequency at which the transmitter laser 51 of node 4 will generate light, the frequency of a resonance peak of the etalon 39 separated by two resonance peaks from the resonance peak frequency aligned with the non-absolute frequency reference signal. In this case, referring again to FIG. 4, the resonance peak 40 is frequency aligned with the non-absolute frequency reference signal and the transmitter laser 51 is frequency aligned with the resonance peak 43 separated by two resonance peaks (41 and 42) from the resonance peak 40. This completes the frequency alignment of the transmitter laser 51 of the transceiver 11 of node 4.

The remaining nodes, including the nodes 5 and 6 of the network 1 are each equipped with a tunable multi-channel device structured to have channels with an identical nominal frequency difference as the channels of the tunable multi-channel device 9 of the node 4. The process described above is used to frequency align the tunable multi-channel device at each of the remaining nodes with the non-absolute frequency reference signal. Additionally, the process just described is used to frequency align the transmitter laser of the transceiver at each of the remaining nodes with a different one of the resonance peaks of the tunable multi-channel device at the respective node.

In operation of node 4 to transmit an optical information signal, modulator 52 receives the light generated by the transmitter laser 51 and additionally receives a transmit information signal. The modulator 52 modulates the light generated by the transmitter laser 51 in response to the transmit information signal to generate a transmit optical information signal. The transmit optical information signal passes through the beam splitter 49 to the optical fiber 3 (FIG. 1), which transmits the transmit optical information signal to another node of the network 1 whose receiver portion is frequency aligned to a resonance peak of an etalon similar to the etalon 39. The resonance peak to which the receiver portion is aligned is separated by two resonance peaks from the resonance peak frequency aligned with the non-absolute frequency reference signal.

The structure and alignment process of an first exemplary embodiment of the receiver portion of the transceiver 11 will be described next with reference again to FIG. 2. The receiver portion of the transceiver 11 in the embodiment shown incorporates a non-coherent optical receiver composed of a receiver laser 61, a tunable optical filter 62 and a high-speed detector 63. The tunable optical filter 62 is arranged to receive a received optical information signal from the optical fiber 3 (FIG. 1) of network 1 and the light generated by the receiver laser 61. The received optical information signal is directed to the tunable optical filter 62 by the beam splitter 49 and the reflector 64. The tunable optical filter filters the received optical information signal, which is typically a multi-frequency optical signal, and provides a filtered optical signal to the high-speed detector 63. The filtered optical signal is composed of a single-frequency optical information signal. An exemplary embodiment of the tunable optical filter 62 is similar in structure to the tunable multi-channel device 7, but differs in that it transmits light in only a single channel that is tunable over a range of wavelengths corresponding to the range of wavelengths of the channels of the network 1. A control circuit similar to the control circuit 44 frequency aligns the tunable filter 62 with the light generated by the receiver laser 61.

A beam splitter 65 directs a small sample of the light generated by the receiver laser 61 through the beam splitter 66 to the beam combiner 48. The beam combiner 48 spatially overlaps the receiver laser light sample with the non-absolute frequency reference signal received from the non-absolute frequency reference 8 and the combined beam passes through the etalon 39 to the detector 45. The feedback signal generated by the detector 45 is fed to the channel selector 9. The channel selector 9 operates as described above to provide a frequency control signal that frequency aligns the receiver laser 61 with a resonance peak of the etalon 39 selected by the channel selector 9. A small dither signal is added to the output of the receiver laser 61 in a manner similar to that described above to facilitate this alignment. The dither signal differs in frequency from those added to the non-absolute frequency reference signal and the transmitter laser 51. As noted above, the tunable optical filter 62 is frequency aligned with the light generated by the receiver laser 61. Hence, the frequency of the received optical information signal that passes through the tunable optical filter 62 to the high-speed detector 63 is frequency aligned with the selected resonance peak. The high-speed detector generates an electrical received information signal in response to the received optical information signal.

FIG. 5 is a block diagram of an exemplary embodiment of the node 4 shown in FIG. 1 incorporating a second embodiment of the receiver portion of the transceiver 11. Elements of the node 4 shown in FIG. 5 that are identical to elements of the node 4 shown in FIG. 2 are indicated using the same reference numerals and will not be described again here.

The receiver portion of the transceiver 11 in this second embodiment incorporates a coherent optical receiver composed of the receiver laser 61, the high-speed detector 63 and an intermediate-frequency filter (IF) and electrical detector (DET) 67. The beam combiner 68 spatially overlaps the received optical information signal received from the optical fiber 3 (FIG. 1) via the beam splitter 49 and the reflector 64 and the light generated by the receiver laser 61. The combined beam illuminates the high-speed detector 63. The received optical information signal is typically a multi-frequency optical signal composed of more than one single-frequency optical information signal, and may be composed of as many single-frequency optical information signals as there are channels in the network 1.

The high-speed detector 63 has a square-law characteristic that, in response to the received optical information signal and the light from the receiver laser 61, generates an electrical signal having frequency components at the sum and difference of the frequency of the light generated by the receiver laser 61 and the frequencies of the single-frequency optical information signals that constitute the received optical information signal. The channel selector 9 frequency aligns the receiver laser 61 in the manner described above with a selected one of the channels of the tunable multi-channel device. The channel corresponds in frequency to one of the single-frequency optical information signals that constitutes the received optical signal. This selected single frequency optical information signal has been transmitted by another of the nodes of the network 1, and is the optical information signal intended to be received by node 4. The frequency range of the electrical difference signal generated by mixing the selected single-frequency optical signal and the light generated by the receiver laser 61 differs from those of the electrical difference signals generated by mixing the remaining, unwanted single-frequency optical information signals with the light generated by the receiver laser 61. The IF filter that is part of the IF filter and electrical detector 67 passes the frequency range of the wanted difference signal and rejects the remaining difference signals. The difference signal passed by the IF filter is detected by the electrical detector that also constitutes part of the IF filter and electrical detector 67 to generate the received information signal.

In the examples just described, in the transceiver 11 of the node 4, the transmitter portion transmits an optical information signal in a channel of the network 1 that will be called a transmitter channel and the receiver portion receives an optical information signal in a channel of the network 1 that will be called a receiver channel. The receiver channel is normally a different channel from the transmitter channel. This allows the node to transmit and receive optical information signals simultaneously. Other embodiments can be structured to transmit and receive optical information signals sequentially. In such embodiments, the transceiver 11 of the node 4 transmits and receives optical information signals using only a single channel of the network. Moreover, in such embodiments, the same laser can serve both as the transmitter laser 51 and the receiver laser 61. Other embodiments lack the transmitter portion or the receiver portion of the transceiver 11. Such embodiments are capable only of receiving or only of transmitting, respectively.

In the examples described above, the transmitter laser at each transmitting node is frequency aligned with a channel of the tunable multi-channel device 7 assigned to the transmitting node, and the receiver laser at each receiving node is frequency aligned with the channel of the tunable multi-channel device assigned to the transmitting node that transmits the optical information signal intended for reception at the receiving node. In other embodiments, the receiver laser at each receiving node is frequency aligned with a channel of the tunable multi-channel device 7 assigned to the receiving node, and the transmitter laser at each transmitting node is frequency aligned with the channel of the tunable multi-channel device assigned to the receiving node to which the transmitting node transmits the optical information signal. In another embodiment, no channels are pre-assigned to the nodes, and optical information signals are transmitted by first searching for a channel of the network in which no optical information signals are currently being transmitted.

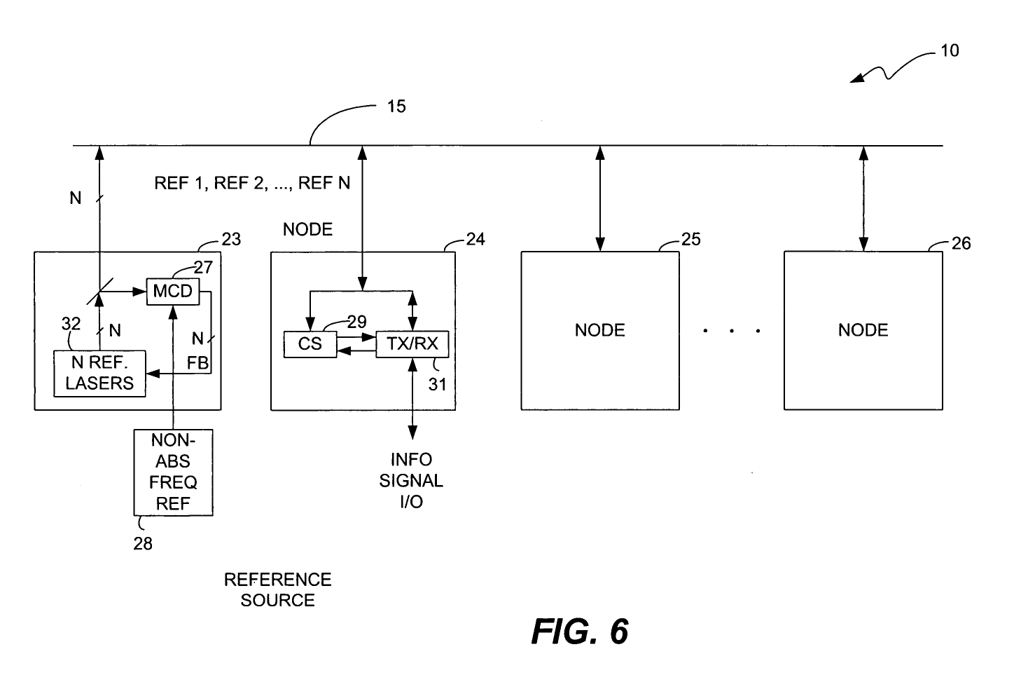

FIG. 6 is a block diagram of a second embodiment of an optical communication network 10 in accordance with the invention. In accordance with this embodiment, non-absolute frequency reference signals are broadcast from a reference source that constitutes a node of the network. The non-absolute frequency reference signals are broadcast to all the nodes of the network. The frequencies of the non-absolute frequency reference signals are not defined in absolute terms, and may vary over time, but the frequency difference between the non-absolute frequency reference signals is accurately and stably defined. In the example shown, the frequency difference between the non-absolute frequency reference signals is defined by a tunable multi-channel device similar to the above-described tunable multi-channel device 7. The frequency difference between the non-absolute frequency reference signals is typically equal to the channel spacing of the network 10.

Every node of the network 10 receives the non-absolute frequency reference signals. Each node chooses at least one of the non-absolute frequency reference signals as a frequency reference signal with which to align the operating frequency of its transmitter laser, its receiver laser or both its transmitter laser and its receiver laser. At each node, a channel selector frequency aligns the transmitter laser of the transceiver located at the node with one of the non-absolute frequency reference signals selected by the channel selector. Additionally or alternatively, the channel selector frequency aligns the receiver laser of the transceiver located at the node with the same or a different one of the non-absolute frequency reference signals selected by the channel selector. The channel selector receives the non-absolute frequency reference signals and provides control signals that frequency align the lasers of the transceiver with selected one or more of the non-absolute frequency reference signals.

In network 10, nodes, exemplary ones of which are indicated by reference numerals 24, 25 and 26, transmit and/or receive optical information signals through the network. Only the structure of node 24 is shown in detail FIG. 6 to simplify the drawing. The remaining nodes 25 and 26 are similar in structure. Node 24 is composed of a channel selector 29 and a transceiver 31.

Also shown in FIG. 6 is a reference source 23. The reference source 23 is a node of the network 10 in which N reference lasers 32 generate the non-absolute frequency reference signals REF 1, REF 2, . . . , REF N at frequencies f1, f2 . . . fN, respectively. The reference source broadcasts the non-absolute frequency reference signals to the other nodes, such as the nodes 24, 25, 26, of the network 10. The reference source 23 broadcasts at least one non-absolute frequency reference signal for each node of the network. The reference source is additionally shown as comprising a tunable multi-channel device 27 and a non-absolute frequency reference 28.

The tunable multi-channel device 27 is similar to the tunable multi-channel device 7 described above with reference to FIG. 2. One channel of tunable multi-channel device 27 is aligned in frequency with a non-absolute frequency reference signal provided by the non-absolute frequency reference 28 in a manner similar to that described above with reference to FIG. 2. A fraction of the light generated by the reference lasers 32 is directed towards the tunable multi-channel device 27. The tunable multi-channel device generates feedback signals FB that are provided to the reference lasers to align the frequency of each of the reference lasers to a respective one of the channels of the tunable multi-channel device 27.

Dither signals of mutually different frequencies are imposed on the non-absolute frequency reference signals generated by the reference lasers 32 to distinguish the non-absolute frequency reference signals from one another and to facilitate frequency aligning the transmitter and/or receiver lasers at the nodes 24, 25, 26 with the non-absolute frequency reference signals. The non-absolute frequency reference signals generated by the reference lasers 32 are spatially overlapped and output from the reference source 23 to the optical fiber 15. The optical fiber 15 transmits the non-absolute frequency reference signals to the nodes, e.g., nodes 24, 25, 26, of the network 10. Thus, the non-absolute frequency reference signals are broadcast to the nodes of the network.

The non-absolute frequency reference signals have amplitudes that are typically a small fraction, e.g., less than about 10%, of the maximum amplitude of the optical information signals transmitted through the network 10. The non-absolute frequency reference signals have frequencies f1, f2, . . . fN that are not defined in absolute terms, but the frequency differences among the non-absolute frequency reference signals are precise and stable.

At the node 24, the non-absolute frequency reference signals REF 1, REF 2, . . . , REF N broadcast through the network 10 by the frequency source 23 are received by the channel selector 29. The channel selector 29 provides control signals to the lasers (not shown) of the transceiver 31. One control signal frequency aligns the transmitter laser at the node 24 with one of the non-absolute frequency reference signals, e.g., REF 1, received from the network 10 and selected by the channel selector. Another control signal frequency aligns the receiver laser at the node 24 with one of the non-absolute frequency reference signals received from the network 10 and selected by the channel selector 29. The one of the non-absolute frequency reference signals may be the same as, but is more typically different from, the non-absolute frequency reference signal with which the transmitter laser at the node 24 is frequency aligned. Similarly, node 25 and node 26 receive one of the non-absolute frequency reference signals broadcast by the frequency source 23. A channel selector similar to channel selector 29 frequency aligns the transmitter laser at each of the nodes with a different one of the non-absolute frequency reference signals, and frequency aligns the receiver laser at each of the nodes with the same or a different one of the non-absolute frequency reference signals.

Once the frequencies of the lasers of the transceivers of all the nodes have each been frequency aligned with different ones of the non-absolute frequency reference signals, an information signal received by the transceiver 31 at each of one or more of the nodes is transmitted as an optical information signal over the fiber 15 to at least one other of the nodes. Each optical information signal is transmitted superimposed on the respective non-absolute frequency reference signal at the same optical frequency. At one or more of the nodes, an optical information signal intended for receipt at the node is isolated from others of the optical information signals passing through the network and is converted into an electrical information signal by the transceiver 31 at the node. The transceivers at the nodes transmit and receive the optical information signals at the optical frequencies defined by the non-absolute frequency reference signals. Although the frequencies of the non-absolute frequency reference signals, and, hence, those of the optical information signals, are not defined in absolute terms, and may change over time, the frequency difference between the non-absolute frequency reference signals and between the optical information signals remains constant and stable. The constant and stable frequency differences allow many optical information signals to be transmitted at different frequencies over the network without mutual interference.

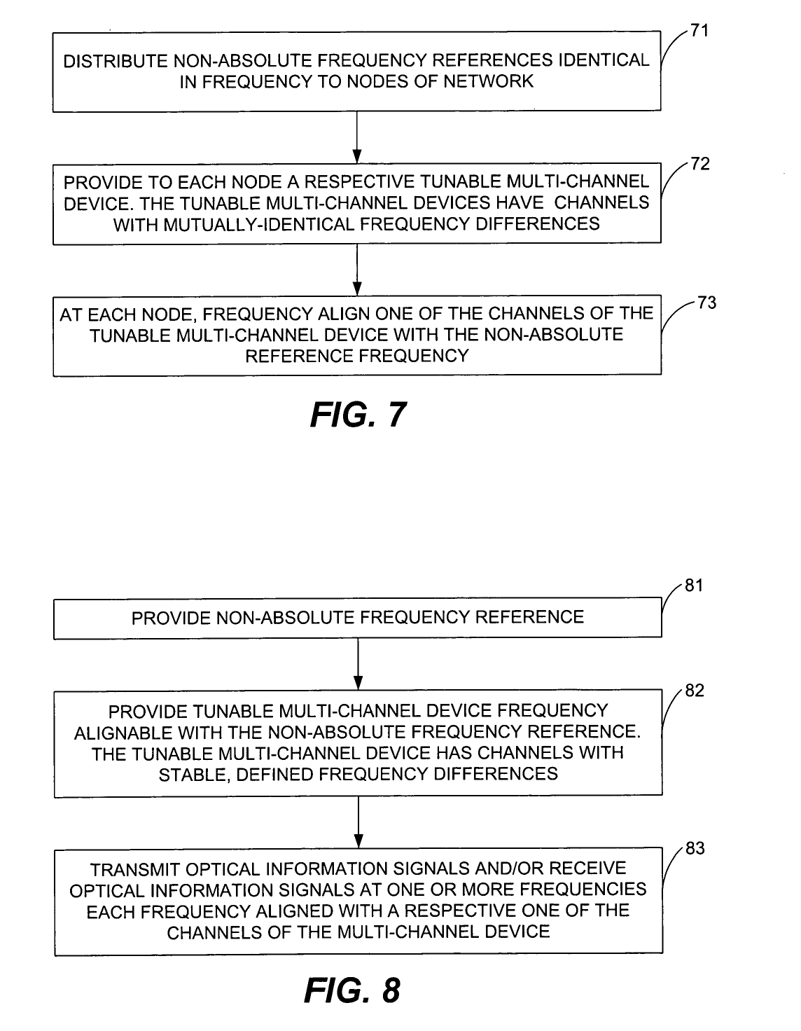

FIG. 7 is a flow chart illustrating a first embodiment of an optical communication method in accordance with the invention in which interoperable optical frequencies are defined without using an absolute frequency reference.

In block 71, non-absolute frequency references identical in frequency are distributed to nodes of a network. In an embodiment, a non-absolute frequency reference signal is broadcast to all of the nodes of the network as the non-absolute frequency references. In another embodiment, respective non-absolute frequency reference artifacts, such as atomic absorption line devices, are provided to the nodes as the non-absolute frequency references. In yet another embodiment, respective non-absolute frequency reference artifacts are provided to some of the nodes and one of the non-absolute frequency reference artifacts, or another, identical non-absolute frequency reference artifact, is used to generate a non-absolute frequency reference signal that is broadcast to the remaining nodes.

In block 72, respective tunable multi-channel devices are provided to the nodes. The tunable multi-channel devices have channels with mutually-identical frequency differences. For example, the frequency difference between the center frequencies of any two adjacent channels is the same for all of the tunable multi-channel devices and for any two adjacent channels.

In block 73, one of the channels of the tunable multi-channel device at each of the nodes is frequency aligned with the non-absolute frequency reference.

After one of the channels of the tunable multi-channel device at all the nodes of the network has been frequency aligned with the non-absolute frequency reference, optical information signals are exchanged between two or more of the nodes at a frequency aligned with another of the channels of the tunable multi-channel device. Specifically, at one of the nodes, a transmitter laser is frequency aligned with the other of the channels of the tunable multi-channel device located at the one of the nodes. At another of the nodes, a receiver laser is frequency aligned with the other of the channels of the tunable multi-channel device located at the other of the nodes. With the transmitter and the receiver frequency aligned to the same channel of the respective tunable multi-channel devices, an optical information signal is transmitted from the one of the nodes to the other of the nodes.

FIG. 8 is a flow chart of a second embodiment of an optical communication method in accordance with the invention in which interoperable optical frequencies are established without an absolute frequency reference. In accordance with this embodiment, in block 81, a non-absolute, frequency reference is provided. In block 82, a tunable multi-channel device frequency alignable with the non-absolute frequency reference is provided. The tunable multi-channel device has channels with stable, defined frequency differences. In block 83, optical information signals are transmitted and/or optical information signals are received at one or more frequencies each frequency aligned with a respective one of the channels of the multi-channel device.

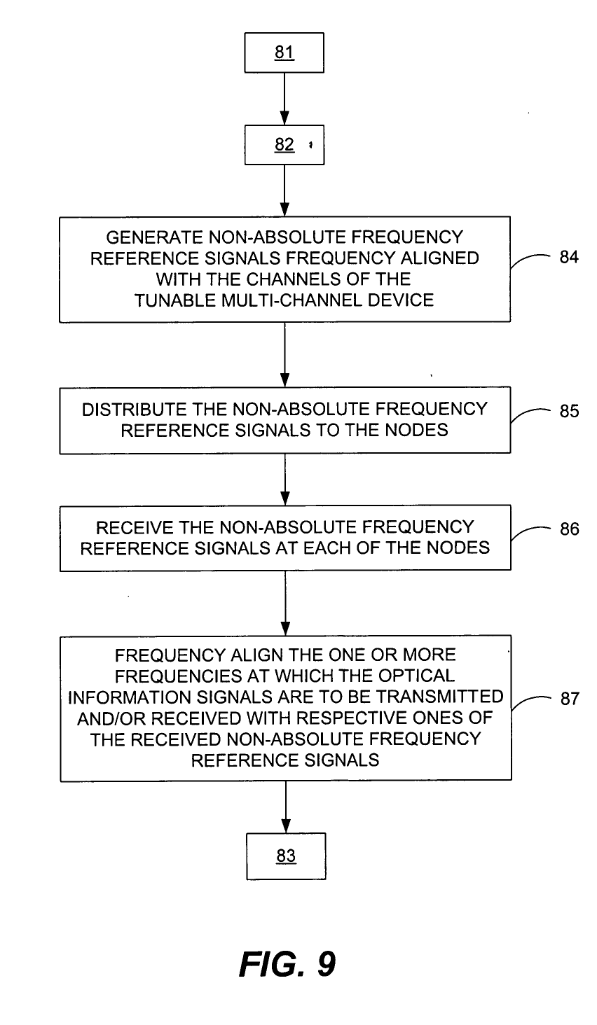

In an embodiment shown in FIG. 9, in which elements identical to those in the method described above with reference to FIG. 8 are indicated using the same reference numerals, and will not be described again here, in block 84, non-absolute frequency reference signals are generated frequency aligned with the channels of the tunable multi-channel device. In block 85, the non-absolute frequency reference signals are distributed to the nodes. In block 86, the non-absolute frequency reference signals are received at each of the nodes, and, in block 87, the one or more frequencies at which the optical information signals are transmitted and/or received are frequency aligned with respective ones of the received non-absolute frequency reference signals.

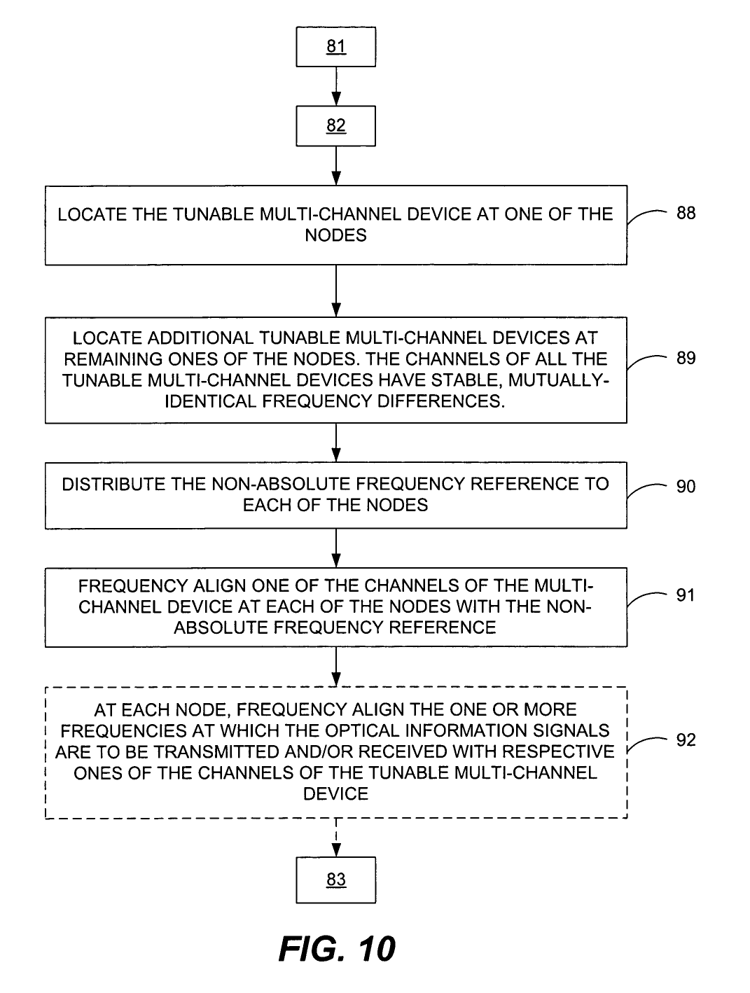

In another embodiment shown in FIG. 10, in which elements identical to those in the method described above with reference to FIG. 8 are indicated using the same reference numerals, and will not be described again here, in block 88, the tunable multi-channel device is located at one of the nodes. In block 89, additional tunable multi-channel devices are located at remaining ones of the nodes. The channels of all the tunable multi-channel devices have stable, mutually-identical frequency differences. In block 90, the non-absolute frequency reference is distributed to each of the nodes. In block 91, one of the channels of the multi-channel device at each of the nodes is frequency aligned with the non-absolute frequency reference. Also shown is optional block 92 in which, at each of the nodes, the one or more frequencies at which the optical information signals are transmitted and/or received are frequency aligned with respective ones of the channels of the tunable multi-channel device located at the node.

The invention has been described with respect to certain exemplary embodiments, but is not limited to such embodiments. Modifications can be made to the embodiments described above and all such modifications are within the scope of the invention as defined by the claims set forth below.

1. A optical communication method in which interoperable optical frequencies are defined without an absolute frequency reference, the method comprising:
distributing non-absolute references identical in frequency to nodes of a network;
providing to the nodes respective tunable multi-channel devices, the tunable multi-channel devices having channels with mutually-identical frequency differences; and
at each of the nodes, frequency aligning one of the channels of the tunable multi-channel device thereat with the non-absolute frequency reference.

2. The method of claim 1, additionally comprising exchanging optical information signals between two or more of the nodes at a frequency aligned with another of the channels of the tunable multi-channel device.

3. The method of claim 1, in which the channels of the multi-channel device provided to at least some of the nodes differ in absolute frequency prior to the tuning.

4. The method of claim 1, additionally comprising:
at one of the nodes, frequency aligning a transmitter laser with another of the channels of the tunable multi-channel device thereat;
at another of the nodes, frequency aligning a receiver laser with the other of the channels of the tunable multi-channel device thereat; and
transmitting an optical information signal from the one of the nodes to the other of the nodes at the frequency aligned with the other of the channels of the tunable multi-channel devices.

5. The method of claim 4, in which the frequency aligning the transmitter laser comprises:
frequency aligning the transmitter laser with the one of the channels of the tunable multi-channel device; and
re-aligning the transmitter laser in frequency with the other of the channels of the tunable multi-channel device.

6. The method of claim 5, in which the re-aligning comprises counting the number of channels between the one of the channels and the other of the channels.

7. The method of claim 1, in which the distributing comprises providing to the nodes non-absolute frequency reference artifacts defining an identical frequency.

8. The method of claim 1, in which the distributing comprises broadcasting a non-absolute frequency reference signal to the nodes.

9. An optical communication method in which interoperable optical frequencies are defined without an absolute frequency reference, the method comprising:
providing a non-absolute frequency reference;
providing a tunable multi-channel device frequency alignable with the non-absolute frequency reference, the tunable multi-channel device having channels with stable, defined frequency differences; and
transmitting optical information signals and/or receiving optical information signals at one or more frequencies each frequency aligned with a respective one of the channels of the multi-channel device.

10. The method of claim 9, in which:
the method additionally comprises generating non-absolute frequency reference signals frequency aligned with the channels of the tunable multi-channel device;
broadcasting the non-absolute frequency reference signals to the nodes; and at each of the nodes:
receiving the non-absolute frequency reference signals, and
frequency aligning the one or more frequencies at which the optical information signals are transmitted and/or received with respective ones of the received non-absolute frequency reference signals.

11. The method of claim 9, additionally comprising:
locating the tunable multi-channel device at one of the nodes;
locating additional tunable multi-channel devices at remaining ones of the nodes, the channels of all the tunable multi-channel devices having stable, mutually-identical frequency differences;
distributing the non-absolute frequency reference to each of the nodes; and
at each of the nodes, frequency aligning one of the channels of the multi-channel device thereat with the non-absolute frequency reference.

12. The method of claim 11, additionally comprising, at each of the nodes, frequency aligning the one or more frequencies at which the optical information signals are transmitted and/or received with respective ones of the channels of the tunable multi-channel device thereat.

13. An optical communication network in which interoperable optical frequencies are defined without an absolute frequency reference, the network comprising:
means for distributing a non-absolute frequency reference to nodes of the network; and
at each of the nodes:
a tunable multi-channel device, the tunable multi-channel devices having channels with mutually-identical frequency differences, and
a control circuit operable to frequency align one of the channels of the multi-channel device thereat with the non-absolute frequency reference.

14. The optical communication network of claim 13, additionally comprising:
at one of the nodes, a transceiver operable to transmit an optical information signal at a frequency aligned with another of the channels of the multi-channel device thereat; and
at another of the nodes, a transceiver aligned in frequency with the other of the channels of the tunable multi-channel device thereat and operable to receive the optical information signal.

15. The optical communication network of claim 14, in which the transceiver operable to transmit comprises:
a light source; and
a channel selector operable to align the light source in frequency with the other of the channels of the multi-channel device.

16. The optical communication network of claim 14, in which the transceiver operable to receive comprises:
a light source;
a channel selector operable to frequency align the light source with the other of the channels of the multi-channel device; and
means, operating in response to light generated by the light source, for selecting an optical information signal for receiving.

17. The optical communication network of claim 13, in which:
the multi-channel device comprises a Fabry-Perot etalon comprising a cavity, the cavity having a length; and
each of the nodes comprises a control circuit operable to tune the etalon by adjusting length of the cavity of the etalon in response to a feedback signal indicative of a frequency difference between a resonance node of the etalon and the non-absolute frequency reference.

18. An optical communication network in which interoperable optical frequencies are defined without an absolute frequency reference, the network comprising:
a non-absolute frequency reference;
a tunable multi-channel device frequency alignable with the non-absolute frequency reference, the tunable multi-channel device comprising channels having stable, defined frequency differences; and
nodes each comprising a transceiver operable to transmit optical information signals and/or to receive optical information signals at one or more frequencies each frequency aligned with a respective one of the channels of the multi-channel device.

19. The optical communication network of claim 18, in which:
the network additionally comprises light sources frequency aligned with the channels of the tunable multi-channel device and operable to generate respective non-absolute frequency reference signals for broadcast to the nodes; and
each of the nodes comprises a channel selector operable to frequency align the one or more frequencies at which the transceiver is operable to transmit and/or receive the optical information signals with respective ones of the non-absolute frequency reference signals received thereat.

20. The optical communication network of claim 18, in which:
the non-absolute frequency reference is distributed to each of the nodes;
the tunable multi-channel device is located at one of the nodes;
remaining ones of the nodes each comprise a tunable multi-channel device, all the tunable multi-channel devices having mutually-identical channel spacings; and
each of the nodes comprises a control circuit operable to frequency align one of the channels of the multi-channel device thereat with the non-absolute frequency reference.

21. The optical communication network of claim 20, in which each of the nodes additionally comprises a channel selector operable to frequency align the one or more frequencies at which the transceiver is operable to transmit and/or receive the optical information signals with respective ones of the channels of the tunable multi-channel device thereat.
